(19) United States
(12) Patent Application Publication
(10) Pub. No.: US 2015/0132130 A1
(43) Pub. Date: May 14, 2015

(54) WIND TURBINE NOISE AND FATIGUE CONTROL

(71) Applicants: NAB & Associates, Inc., San Diego, CA (US); Noise Control Engineering, LLC, Billerica, MA (US)

(72) Inventor: Neal A. Brown, San Diego, CA (US)

(21) Appl. No.: 14/538,511

(22) Filed: Nov. 11, 2014

Related U.S. Application Data
(60) Provisional application No. 61/903,291, filed on Nov. 12, 2013.

(51) Int. Cl. F03D 7/02; F03D 7/04; F03D 11/00

(52) U.S. Cl. CPC F03D 7/022; F03D 11/0091; F03D 7/04
USPC 416/43; 416/44

(57) ABSTRACT

Embodiments of wind turbine control systems, and related methods, are disclosed herein. For example, a wind turbine control system may include: a measurement system, including one or more measurement devices disposed on a blade of a wind turbine, to generate a measurement signal representative of a response of the blade to turbulence or flow non-uniformity; a force generation system to generate lift proximate to a trailing edge of the blade by generating a blowing jet of air at the trailing edge of the blade in response to a control signal; and a controller device to generate the control signal, based at least in part on the measurement signal, for provision to the force generation system to reduce the response of the blade to turbulence or flow non-uniformity. Other embodiments may be disclosed and/or claimed.

### CROSS-REFERENCE TO RELATED APPLICATION

This application claims priority to U.S. Provisional Patent Application No. 61/903,291, filed Nov. 12, 2013, and titled “WIND TURBINE NOISE AND FATIGUE CONTROL,” the entirety of which is incorporated by reference herein.

### FIELD

Embodiments of the present disclosure generally relate to the field of wind turbines, and more particularly, to wind turbine noise and fatigue control.

### BACKGROUND

Wind turbine operation presents a number of challenges. Wind turbine components experience wear and fatigue from a number of sources, such as rotor blade bending under fluctuating aerodynamic loads and/or rotor hub, shaft, bearing, and gear loads. Additionally, wind turbines may generate audible “swishing” sounds and non-audible noise that is distracting or uncomfortable for people in the vicinity. These challenges remain largely unaddressed, and impede adoption of wind turbine technology.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a perspective view of a wind turbine, in accordance with various embodiments.

FIG. 2 is an axial view of a blade of a wind turbine rotor, in accordance with various embodiments.

FIG. 3 is a block diagram of a wind turbine control system, in accordance with various embodiments.

FIG. 4 is a block diagram of an embodiment of a measurement system of a wind turbine control system.

FIG. 5 is a rotor axial view of a blade including various measurement devices, in accordance with various embodiments.

FIG. 6 is a block diagram of an embodiment of a force generation system.

FIG. 7 is a rotor axial view of a blade including a blowing jet system, in accordance with various embodiments.

FIG. 8 is a blade cross-sectional view of an embodiment of the blowing jet of FIG. 7.

FIGS. 9A-9C are cross-sectional views of various angular position configurations of a rotatable regulator in an embodiment of the blowing jet of FIG. 8.

FIG. 10 is a block diagram of an embodiment of a controller device.

FIG. 11 is a schematic illustration of an embodiment of the controller device of FIG. 10 for mitigation of radiated infrasound.

FIG. 12 is a graph of the Theodorsen function, in accordance with various embodiments.

FIG. 13 is a graph of the Coanda control blowing power versus bending moment, in accordance with various embodiments.

FIG. 14 is a graph of the Coanda control lift versus blowing coefficient, in accordance with various embodiments.

FIGS. 15 and 16 are views of a track-mounted sonic detection and ranging (SODAR) system for measuring the wind velocity distribution around a wind turbine, in accordance with various embodiments.

FIG. 17 illustrates a linearized profile of an eccentric cylinder included in a rotatable regulator, in accordance with various embodiments.

FIGS. 18 and 19 are schematic illustrations of nozzle gap variation for the eccentric cylinder of FIG. 17, in accordance with various embodiments.

### DETAILED DESCRIPTION

Embodiments of the present disclosure describe wind turbine control systems and related devices and methods. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, vertical/horizontal, above/below, and the like. Such descriptions are merely used to facilitate the discussion and are not intended to restrict the application of embodiments described herein to any particular orientation. The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the phrase “coupled” may mean that two or more elements are in direct physical or electrical contact, or that two or more elements are not in direct contact with each other, but yet still cooperate or interact with each other (e.g., via one or more intermediate elements, which may perform their own transformations or have their own effects). For example, two elements may be coupled to each other when both elements communicate with a common element (e.g., a memory device). As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

Various ones of the wind turbine control systems disclosed herein may be configured to mitigate infrasound generated during the operation of a wind turbine. Infrasound often appears at frequencies below that audibly sensible to humans. Although it may not evoke an auditory response in the normal sense, it may be sensed in other modalities. Since all sound, including in the very low frequency region, is manifest as pressure variations in the surrounding fluid medium (typically air, although infrasound may also be present with important effects underwater), persons exposed to threshold levels of infrasound may experience an awareness of the infrasound and even discomfort. This is apparently true in a number of persons who dwell in the vicinity of one or more operating wind turbines, particularly if such machines are large and relatively close by. Many complaints of infrasound occur in response to harmonics of the blade rate (typically approximately ¾ hertz) and commence around 10 hertz, and there is now a body of evidence that common levels of infrasound are objectionable and possibly harmful to humans. The perceived effects are usually accompanied by audible sound that may occur in intervals at infrasound periodicities. When the distance of the observer from the wind turbine source is adequately large (on the order of a diameter of the swept area of the rotor of the wind turbine, or more), and in the absence of any supersonic or trans-sonic velocities of moving parts, the physical source of radiated infrasound may be found in periodic or quasi-periodic fluctuations of the aerodynamic forces on the blades of the wind turbine.

In particular, infrasound may be the result of cumulative thrust fluctuations on the rotor of a wind turbine. Roughly speaking, if a correlation radius of wind turbulence will pass between the blade tips (tips of adjacent blades), the total spectrum will be smooth or featureless. If the correlation radii are greater than this, narrow band energy, centered about the blade rate frequencies, will appear. For very large correlation length, the spectrum approaches a line spectrum, for the flow field then becomes organized into a stationary non-uniform wake.

The intensity of radiated infrasound may vary as the cosine of the conical angle measured away from the axis of rotor rotation (in nominally horizontal axis wind turbines, as depicted in FIG. 1), and inversely as the square of the distance from the rotor hub (in FIG. 1, located at the nacelle 104). There may also be radiation in the plane of the rotor motion due to torque fluctuations, but it is generally weaker in intensity and more fragmented in its directivity. When the collective thrust fluctuations of the rotor radiate axially in dipole fashion, a degree of axial directivity results (even at low harmonics of the blade rate) because the diameter of the radiator is that of the rotor. That diameter (typically 100 meters or more) may be commensurate with the acoustic wavelength at the fourth harmonic. While a wake from the pillar of the wind turbine may be avoided by positioning the rotor forward of the pillar, the rotor may be capable of generating significant radiating collective thrust fluctuations when operating in large-scale wind turbulence. The human-audible noise range may begin at about 20 hertz, with turbulence wavelength scales of less than two meters. At that scale, blade lift fluctuations may be local, and uncorrelated among blades.

The swishing noises often reported by bystanders to wind turbine operation may be a result of separation of the turbulent boundary layer (TBL) airflow on the blade airfoil sections at the trailing edges. This separation flow may result in spanwise “vortex shedding” from the trailing edges, with associated lift fluctuations having a substantial bandwidth in the audible range. Laminar flow shedding, by contrast, may be more narrow-band. The fluctuating local lift forces may radiate sound in dipole fashion, in the force direction. This kind of noise may be highly air-speed dependent, with the radiated acoustic power varying as the 6th power of the tip speed. This vortex-shedding sound may be subject to amplitude and frequency modulation by variations in lift loading of the rotor. Thus, the rotor may experience a once-per-revolution modulation on individual blades due to load variations in the sheared wind flow, and a modulation at the blade rate due to passing through the locally slowed wind velocity where the wind is blocked upstream of the pillar.

In some embodiments of the wind turbine control systems disclosed herein, the wind turbine control system may be configured to mitigate the fatigue loads on wind turbine components typically induced during operation. Fatigue may be caused by once-per-revolution gravity loading, rotor blade bending, and other aerodynamic loading when operating in turbulent and non-uniform winds. Large-scale turbulence may cause collective thrust and torque fluctuations on the rotor, nacelle, and pillar of the wind turbine (e.g., the rotor 112, the nacelle 104, and the pillar 106 of the wind turbine 100 of FIG. 1). These thrust and torque fluctuations may have frequency content (e.g., bandwidths) that depends on the scale of the turbulence.

The fluctuating forces on the blades of a wind turbine may be the result of fluctuations in the angle-of-attack of the air velocity relative to the blades as they rotate. These fluctuations in the angle-of-attack may be due to the turbulence in the wind approaching and passing through the blade's swept area. In earlier times, some wind turbine rotors were placed downstream of their supporting towers, the aerodynamic wakes of which resulted in a thumping at the blade rate. Because of the noise and the possible fatigue damage to the blades of a wind turbine, the current standard practice is to locate blades of important wind turbines upstream, to windward of their pillars.

Dynamic characteristics of the operation of propellers may be usefully applied in the wind turbine context. The spectra of the net forces acting on a propeller when operating in a turbulent inflow may contain bands of energy centered on the various multiples of the blade rate, and may depend on the spatial frequency (the “wavenumber”) spectrum of the fluid-convected turbulence, as well as on the geometric characteristics and operating conditions of the propeller. In the case of a propeller, the inflow may be accelerated as it approaches the propeller disc, so that in the vicinity of the propeller blades, the turbulence velocities constitute a smaller percentage of the convection velocity than in the approaching stream. Conversely, in the case of a wind turbine, the inflow may be decelerated as it approaches the rotor of the wind turbine, so that the turbulence velocities in the vicinity of the moving rotor constitute a greater percentage of the through-flow velocity than in the free wind. As the radiated pressures generated and experienced by the wind turbine may be dependent upon the collective rotor thrust forces and their frequencies, reducing or adjusting either or both may be effective in mitigating infrasound. However, since the frequencies of forces operating on a wind turbine are typically dependent on engineering features that are chosen on the bases of economy and capacity (e.g., the number of blades and the blade rate), adjusting the frequencies of forces may not be practicable in real-world wind turbine applications. An advantageous approach, presented herein, is to controllably create aerodynamic thrust forces on the blades that may oppose and thereby collectively cancel those forces that are created by the interaction of the blades with the turbulent airflow.

A force generation (excitation) mechanism is described above for a turbine operating in a turbulent wind flow. Radiation from the net forces on the rotor blades that are correlated among them may be describable in a manner similar to that from a source disc in the rotor plane with equal diameter. The directivity pattern of the acoustic radiation is determined by the ratio of the wavelength to the diameter, using acoustic principles. As noted above, various embodiments disclosed herein are directed to addressing noise at infrasound frequencies, wherein the acoustic wavelength is larger than the radius of the turbine rotor. In the infrasound range, the directly radiated acoustic power output may result largely from the net unsteady forces and moments acting between the rotor and the air. That radiation may be dipole and quadrupole, respectively, in nature, with the former being considerably greater in magnitude than the latter. In particular, the major infrasound contributor may be that associated with the fluctuating net thrust force, F, on the rotor. Focusing on the infrasound generated by this fluctuating net thrust force, F, the acoustic power, P, radiated by a rotor acted on by these thrust forces may be largely described by the following dipole relation:

P=ω²F²/12πρc³

where ω is the radian frequency of the force, ρ is the mass density of the air, and c represents the speed of sound. Since the square of a sum is greater than or equal to the sum of squares, the greatest radiation may occur when the forces on the individual rotor blades occur simultaneously, that is, when the time varying blade forces are in phase. This may occur at frequencies that are integral multiples of the blade rate.

Prior wind turbine control approaches have not addressed the infrasound issue. Techniques for generating blade forces have been described for varying the loading of wind turbines, such as pitch control. Techniques have also been described for application to wind turbine rotor blades of controllable trailing edge or leading edge flaps for load control by collective action on the rotor blades—independently of or in replacement of pitch control. These sorts of approaches are steady-state operators purported to address slow or long-term variations of aerodynamic lift modulations. The systems developed for such applications are inappropriate for use in short-term, dynamic lift modulation applications, such as the mitigation of infrasound, since actuators capable of achieving high rates of actuation, while avoiding fatigue failure or degradation with wear, are not known or available. Weather and temperature provide further mechanical challenges to the use of flap-based technology.

Moreover, dynamic lift modulation is further complicated by frequency dependent effects that have not been adequately addressed by flap-based or other conventional technologies. For example, as demonstrated in the work of Theodorsen, von Karman, and Sears in Aeroelasticity (Bisplinghoff, R. L., H. Ashley, & R. L. Halfman; Dover, 1996), time-varying lift (due to, e.g., oscillatory motion of a control surface, or of oscillatory modulation of a boundary-layer control blowing flow, or even of incidence changing turbulence velocities in an incoming airflow) is subject to a frequency dependent factor that affects both the amplitude and phase of that lift relative to its quasi-steady value. The governing dimensionless parameter is the product of the wavenumber, k, with the blade section semichord length, b. The wavenumber is the spatial analogue of temporal frequency, w, and may be defined in accordance with

k=ωb/U,

where U is the average relative velocity (the “flight speed”).

The unsteady response lift factor is known as the Theodorsen function, C(k), which may be defined in accordance with

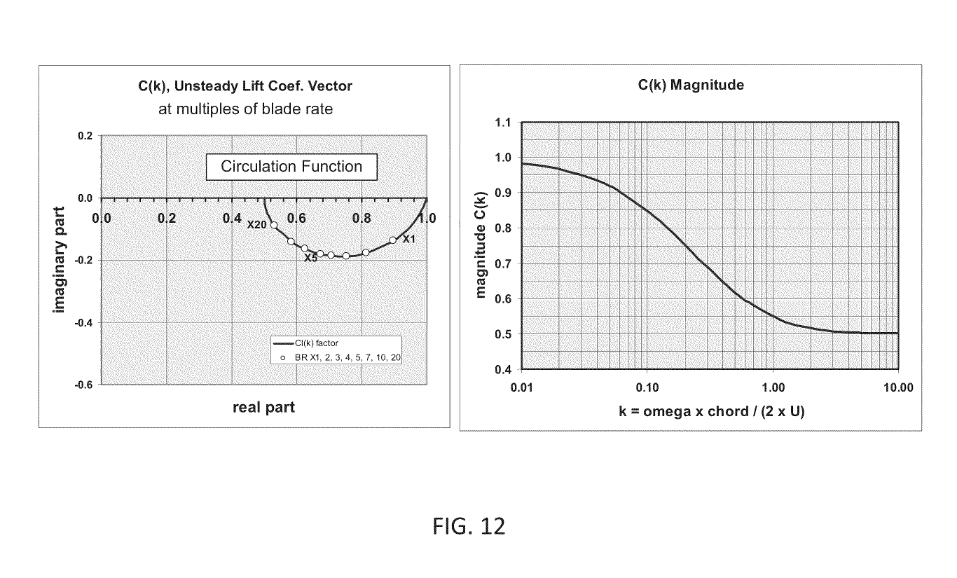

C(k)=H1(k)/[H1(k)+iH0(k)]

where the H functions are Hankel functions of the 2nd kind, and “i” is the imaginary operator. The Theodorsen function is a complex function that relates the ratio of the lift coefficient produced by a sinusoidally varying angle-of-attack (in either time or path-length) to that produced by an equal-but-constant angle-of-attack, and thus the Theodorsen function represents a factor relating the unsteady response to the steady response. The Theodorsen function is shown plotted in FIG. 12. The Theodorsen function consists of both real and imaginary parts (that is, having both amplitude and phase). At high enough wavenumber values, the Theodorsen factor is approximately equal to the real value 0.5. At intermediate wavenumber values, the function is seen to represent a phase (time) lag, as well as an intermediate amplitude reduction relative to the quasi-steady response (at k=0). A further inertial factor may not play a significant role in the applications discussed herein.

In some embodiments, the wind turbine control systems disclosed herein may mitigate infrasound by reducing or canceling certain harmonics in the pressure waves generated by a wind turbine during operation. In particular, infrasound may be mitigated by a wind turbine control system by implementing control techniques that address thrust variations at the blades. In some embodiments, the fatigue experienced by the blades may also be mitigated by reducing stresses on the blades. The wind turbine control systems may utilize the intelligent management techniques disclosed herein for managing the forces experienced by the blades.

In some embodiments, the systems and techniques disclosed herein may generate fluctuating forces that may be experienced by the blades of a wind turbine by using Coanda circulation effects in a novel, time-varying setting. The Coanda effect may refer to the phenomenon whereby a thin, high velocity jet of fluid “sticks” to a curved, convex, trailing edge of an airfoil (e.g., a blade of a wind turbine), and embodiments of wind turbine control systems that utilize the Coanda effect may be referred to herein as implementing Coanda circulation control (CCC). In some embodiments, CCC may be viewed as related to conventional boundary layer control (BLC) via blowing and suction. Since lift is proportional to aerodynamic circulation, a blade included in an embodiment of a wind turbine control system employing CCC, as disclosed herein, may experience an increased lift coefficient. In particular, a section of the blade may be provided with a rounded trailing edge over and tangentially to which an air jet is blown. This air jet may be a high velocity, high momentum jet formed substantially as a thin sheet, for example. Such an air jet may be referred to as a “wall-jet.” Under the influence of this wall-jet, the boundary layer of the blade may “attach” along the rounded surface of the trailing edge of the blade, thereby moving the rear stagnation point of the blade toward the pressure (nominally lower) side of the blade and increasing the circulation and lift experienced by the blade. For example, various ones of the embodiments disclosed herein may include a force generation system that selectively discharges an air wall-jet from above or below a rounded trailing edge of a blade in order to controllably generate positive or negative lift.

The CCC-based embodiments disclosed herein may achieve aerodynamic results analogous to those achieved by trailing edge “flaps” (e.g., aileron structures) that are positioned at controllable deflection angles to generate lift fluctuations via the deflected air, but the CCC-based embodiments disclosed herein may be much more resilient to mechanical failure and thus may achieve practical performance results that far exceed any conventional “flap-based” approaches. For example, as discussed in further detail below, some of the embodiments disclosed herein may generate a jet by rotating a specially configured rotatable regulator located at a trailing edge of a blade of a wind turbine. Relative to a conventional flap, this rotational regulator may experience relatively little mechanical load or wear during use. Although such blowing jet-based configurations may require a pressurized air source to provide the jet (and thus may incur energy costs to pump the air), high reliability technologies for doing so are known, and thus an overall performance improvement may be achieved. Moreover, the CCC-based approaches disclosed herein may achieve dynamic responses that cannot be achieved by flap-based systems (e.g., as the blade-rate harmonic number is increased for frequencies nearing the lower threshold of hearing, nominally 20 Hz).

These systems and techniques may respond to load variations that are highly time variable and oscillatory, which may present additional and different challenges than control of quasi-steady loads. In particular, various embodiments of the control systems disclosed herein may mitigate environmental noise forces on a short time scale (due, e.g., to flow non-uniformity and turbulence). Although devices utilizing the Coanda effect have previously been used to adjust the operating point of a propeller, the potential for Coanda-related effects in the area of vibration control in wind turbines has not been recognized, nor realized in a robust implementation.

FIG. 1 is a perspective view of a wind turbine 100, in accordance with various embodiments. The wind turbine 100 may include a pillar 106, which may support a nacelle 104. A rotor 112, comprising one or more blades 102, may be coupled to the nacelle 104 and may rotate in the direction indicated by the arrow 108 in response to wind blowing in the direction generally indicated by the arrow 110. Three blades 102 are depicted in FIG. 1, but more or fewer blades may be included in the wind turbine 100. The product of the rate of rotation of the rotor 112 and the number of blades 102 of the rotor 112 may be referred to as the “blade rate,” and may be measured in hertz or any other suitable units.

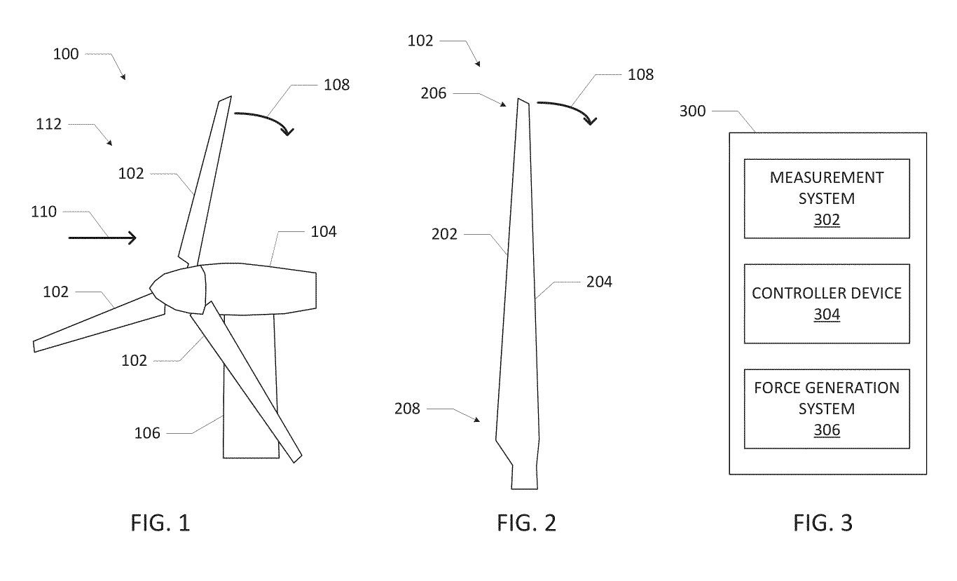

FIG. 2 is an axial view of a blade 102 of the rotor 112 of the wind turbine 100, in accordance with various embodiments. The blade 102 may have a leading edge 204, a trailing edge 202, a tip 206, and a root 208.

FIG. 3 is a block diagram of a wind turbine control system 300, in accordance with various embodiments. The system 300 may include a measurement system 302, a controller device 304, and a force generation system 306. The system 300 may be configured to control the operation of the wind turbine 100 to achieve any of a number of performance objectives, as discussed below. Although the operation of the system 300 is discussed below with reference to the control of the wind turbine 100, the system 300 may be utilized to control any appropriate wind turbine or propeller arrangement. The control system 300 may be implemented using any suitable processing devices coupled with conversion circuitry, power amplification circuitry, communication circuitry, memory devices configured with machine-readable media having instructions for performing various operations, and/or any other suitable hardware.

The measurement system 302 may be coupled to the controller device 304, and may include one or more measurement devices disposed on the blade of a wind turbine (e.g., the blade 102 of the wind turbine 100). The measurement system 302 may be configured to generate a measurement signal representative of a force on the blade 102 and/or a speed of a portion of the blade 102. For example, in some embodiments, measurement devices included in the measurement system 302 may measure stresses or strains in the root 208 of one or more of the blades 102 and/or the motion of one or more of the blades 102. Measurements made by the measurement system 302 may represent the alternating aerodynamic thrust experienced by wind turbine blades due to oscillatory and time-varying forces. For example, in some embodiments, the force represented by the measurement signal may be indicative of a response of the blade 102 to air turbulence or flow non-uniformity. The measurement signal generated by the measurement system 302 may be provided to the controller device 304.

The force generation system 306 may be coupled to the controller device 304, and may be configured to generate a force on the blade 102. In some embodiments, the force generation system 306 may be configured to induce an aerodynamic lift on the blade 102. In some embodiments, the force generation system 306 may be configured to generate forces on the blades 102 of the wind turbine 100 to utilize the Coanda effect to provide CCC, as discussed throughout this disclosure. For example, as noted above, various ones of the embodiments disclosed herein may include a force generation system 306 that selectively discharges an air wall-jet from above or below a rounded trailing edge 202 of the blade 102 in order to controllably generate positive or negative lift.

The controller device 304, which may be coupled to the measurement system 302 and the force generation system 306, may be configured to generate a control signal for provision to the force generation system 306 to mitigate the effects of fluctuating environmental forces by generating countervailing forces at one or more frequencies. In some embodiments, the controller device 304 may be configured to generate a control signal for provision to the force generation system 306 to reduce the response of the blade 102 to turbulence or flow non-uniformity. In some embodiments, the controller device 304 may generate the control signal based at least in part on the measurement signal generated by the measurement system 302.

Measurement signals, control signals, electrical power, hydraulic fluids, and any other elements of the system 300 may be carried by appropriate cabling or tubing included in various portions of the wind turbine. For example, signal and power cables for the blowing jet system of FIG. 7 may be carried in electrical cables embedded in the trailing edges 202 of each blade 102. Such cables may emanate from the nacelle 104 and may be coupled with cables in the pillar 106 via slip rings or other coupling devices.

As noted above, in some embodiments, the system 300 may be configured to mitigate infrasound generated during the operation of the wind turbine 100 as the result of cumulative thrust fluctuations on the rotor 112. The system 300 may be configured to mitigate fatigue on wind turbine components typically induced during operation (e.g., due to once-per-revolution gravity loading, rotor blade bending, and other aerodynamic loading when operating in turbulent and non-uniform winds), as discussed above, by controllably creating aerodynamic thrust forces on the blades 102 that may oppose and thereby collectively cancel those forces that are created by the interaction of the blades 102 with the turbulent airflow. In some embodiments, the system 300 may mitigate infrasound by reducing or canceling certain harmonics in the pressure waves generated by the wind turbine 100 during operation. In particular, infrasound may be mitigated by the system 300 by implementing control techniques that address thrust variations at the blade 102. In some embodiments, the fatigue experienced by the blades 102 may also be mitigated by reducing stresses on the blades 102.

The following paragraphs describe various embodiments of the measurement system 302, the controller device 304, and the force generation system 306. Any of these embodiments may be combined in any desired and suitable arrangement to form an embodiment of the system 300.

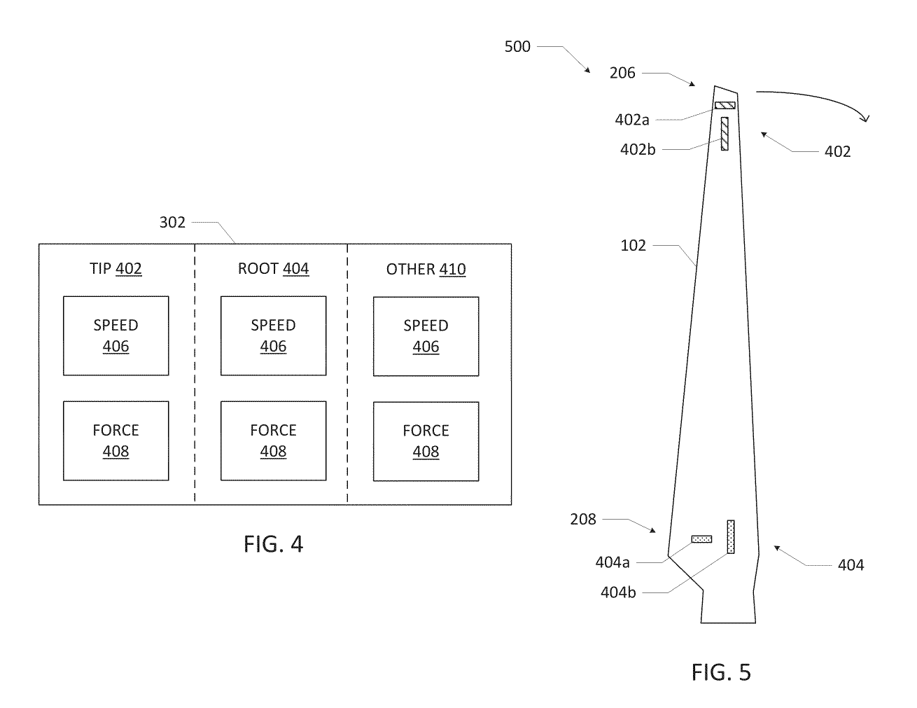

FIG. 4 is a block diagram of an embodiment of the measurement system 302 of the system 300 (FIG. 3). The measurement system 302 may include tip measurement devices 402 (which may include zero, one, or more measurement devices disposed proximate to the tip 206 of the blade 102), root measurement devices 404 (which may include zero, one, or more measurement devices disposed proximate to the root 208 of the blade 102), and/or other measurement devices 410 (e.g., those disposed at any location along the length of the blade 102). Measurement devices (e.g., strain gauges) may be embedded in a laminate material of the blade 102 or otherwise affixed to the blade 102.

The tip measurement devices 402, the root measurement devices 404, and/or the other measurement devices 410 may include zero, one, or more vibratory velocity measurement devices 406. In some embodiments, the velocity measurement devices 406 may include a velocimeter (which may take the form of a magnet on a spring within a coil of wire), an accelerometer, or any other such device. Velocimeters may be advantageously used in some embodiments, as commercially available velocimeters may have adequate sensitivity at the low frequencies of interest, may be very rugged, may require no excitation, and may have modest cost. For example, velocimeters commonly used in geophysical survey may be used. The speed measurement devices 406 may measure a vibratory velocity of the blade 102 in one or more directions, such as an axial direction (parallel to the longitudinal axis of the shaft of the rotor 112).

The tip measurement devices 402, the root measurement devices 404, and/or the other measurement devices 410 may include zero, one, or more force measurement devices 408. In some embodiments, the force measurement devices 408 may include a strain gauge. The force measurement devices 408 may measure a force, stress, or strain of the blade 102 in one or more directions, such as an axial direction.

Any desired combination of tip, root, or other measurement devices may be used. For example, in some embodiments, axial motion of the tip 206 of the blade 102 may be measured (e.g., by one or more velocimeters included in the measurement system 302) and this motion may be provided to the controller device 304 for use in generating a control signal for the force generation system 306 that may change the thrust experienced by the blade 102 (e.g., by reducing (or increasing) the net force on the blade at one or more harmonic frequencies of the blade rate). In some embodiments, the instantaneous velocities of oscillation of each blade 102 may be sensed by identical measurement devices, integral with the blades 102 and located at a common radially outward position. In some embodiments, these measurement devices may be tip measurement devices 402, and may be located within the outer 10% of the length of the blade 102. In some embodiments, including measurement devices 402 only in the outer 10% of the length of the blade 102 may provide adequate data for performing CCC.

In some embodiments, the measurement system 302 may include one or more acoustic Doppler velocimetry (ADV) units arranged to provide a real-time survey of the velocity field of the air incoming to the rotor 112. For example, an ADV unit, mounted at the hub of the rotor 112, may resolve a “map” of velocities in a plane that cuts across the approaching wind stream at a distance of one rotor diameter. Data from the ADV unit of the measurement system 302 may be provided to the controller device 304, which may apply a conventional computational fluid dynamics (CFD) model to the ADV data and take account of the deceleration of the wind stream as it approaches the loaded rotor 112 to estimate the spatial distribution of turbulent wind velocity non-uniformities to be expected at the rotor 112 in advance. This “prediction” of turbulent wind velocity non-uniformities may allow the controller device 304 to plan the distribution and magnitude of unsteady lift force mitigation actuations (by the force generation system 306), which may provide improved control relative to control based on instantaneous rotor-resident motion and stress sensors. In some embodiments, only instantaneous sensors and force determinations may be made.

FIG. 5 is a rotor axial view of an embodiment 500 of the blade 102 including various measurement devices in the measurement system 302, in accordance with various embodiments. As shown in FIG. 5, the tip measurement devices 402 include two tip measurement devices 402a and 402b. The tip measurement device 402a (which may be, for example, a speed measurement device 406) may be arranged to measure the speed of the tip 206 in a direction perpendicular to the plane of the rotor 112. The tip measurement device 402a (which may be, for example, a vibratory velocity measurement device 406, such as a velocimeter) may be arranged to measure the vibratory velocity of the tip 206 in a rotor-axial direction.

FIG. 5 also depicts root measurement devices 404 including two root measurement devices 404a and 404b. The root measurement device 404a (which may be, for example, a force measurement device 408) may be arranged to measure a force on the root 208 in a direction tangential to the longitudinal axis of the blade 102. The root measurement device 404a (which may be, for example, a force measurement device 408, such as a strain gauge) may be arranged to measure a stress on the root 208 for bending.

The arrangement and selection of measurement devices in the embodiment of FIG. 5 is simply illustrative, and any desired arrangement and selection may be used. For example, in some embodiments, fluctuating aerodynamic forces (primarily lift, that force component perpendicular to the direction of the net inflow relative to the moving blade 102) may be proportional to the square of that relative velocity (the vector sum of the radius-dependent tangential velocity of the rotating rotor 112 and the radius- and blade angle-dependent axial vibratory velocity of the turbine load-retarded wind) and may be maximal at the outermost radial positions at the tip 206 of the blade 102. Therefore, in some embodiments, sensing of the forces experienced by the blades 102 at those outermost locations may be most representative of the associated radiation.

The radiation may be sensed, in some embodiments, by sensing the front-to-back motions of the blades 102 that result from those forces via the flexibility of the blades 102. Thus, in some embodiments, one or more vibratory velocity measurement devices 406 may be included in each blade 102 at identical radial positions. These vibratory velocity measurement devices 406 may be oriented parallel to the axis of rotation of the rotor 112. A set of velocimeters may be preferred in some embodiments, as their frequency response may increasingly suppress higher frequency signals relative to the frequency response of accelerometers. Accelerometers, by contrast, may exhibit a sensitivity that increases with frequency, and thus may not provide sufficient performance (e.g., a sufficient signal-to-noise ratio) when employed to sense very low frequency motions of the blades 102 (those that indicate the presence of infrasound-radiating forces). However, in some embodiments, accelerometer signals may be low-pass filtered to clearly reveal the instantaneous forces themselves (vs. the time-lagged motions), which may be suitable for counter-force control actuation as discussed herein. Accelerometers that require a power supply (as is common) may be less suitable (e.g., relative to velocimeters, which typically do not).

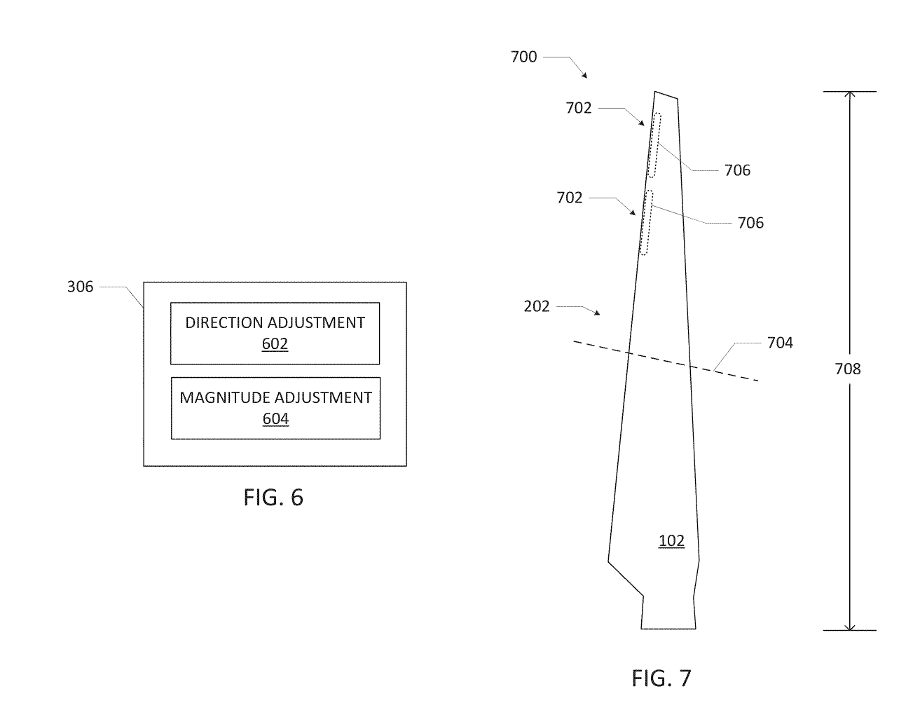

FIG. 6 is a block diagram of an embodiment of the force generation system 306 of the system 300 (FIG. 3). As noted above, the force generation system 306 may be configured to induce a force on the blade 102. The forces induced by the force generation system 306 may be generated in response to control signals from the controller device 304, and may result in reducing the axial motions of the blades 102 at harmonics of the blade rate by aerodynamic contra-forcing of the blades 102, for example. The force generation system 306 may include a direction (phase) adjustment component 602 and a magnitude adjustment component 604.

The direction adjustment component 602 may include mechanical and/or electrical components to adjust the direction in which the force generation system 306 induces a force on the blade 102. The magnitude adjustment component 604 may include mechanical and/or electrical components to adjust the magnitude of a force induced by the force generation system 306 to the blade 102. The direction adjustment component 602 and the magnitude adjustment component 604 may be independently controllable by the control signal provided to the force generation system 306, or adjustment of one may be related to adjustment of the other in various embodiments.

As noted above, in some embodiments, the force generation system 306 may be configured to induce a circulatory lift on the blade 102. The force generation system 306 may be controllable (e.g., by the controller device 304) to adjust the magnitude and/or direction of this force during operation of the wind turbine 100.

In some embodiments, the force generation system 306 may include a blowing jet system, which may utilize one or more adjustable jets of blowing air to induce desired forces to the blade 102. FIG. 7 is a rotor axial view of the blade 102 including a blowing jet system 700, in accordance with various embodiments. The blowing jet system 700 may include one or more blowing jets 702. Each blowing jet 702 may be supplied by a reservoir of pressurized air (not shown in FIG. 7) coupled with a rotatable regulator 706. In some embodiments, two or more of the blowing jets 702 may share the same reservoir of pressurized air, which may be disposed within the blade 102 or within another structure (e.g., the nacelle 104, the hub of the rotor 112, or the pillar 106). Although the blowing jets 702 are depicted in FIG. 7 in a portion of the blade 102 closest to the tip 206, in other embodiments, the blowing jets 702 may be positioned in any suitable portion of the blade 102 (e.g., along the entire trailing edge 202 of the blade 102).

In some embodiments, the rotatable regulator 706 of a blowing jet 702 may have a longitudinal axis, and this longitudinal axis may be arranged proximate to and approximately in parallel with a portion of the trailing edge 202 of the blade 102. As illustrated in FIG. 7, the rotatable regulators 706 may form the trailing edge 202 of the blade 102. As shown in FIG. 7, the longitudinal axes of the rotatable regulators 706 of the blowing jets 702 may all be arranged in parallel with the trailing edge 202 of the blade 102. The rotatable regulator 706 of a blowing jet 702 may be rotatable about a longitudinal axis of the rotatable regulator 706. Any suitable mechanism may be used to rotate the rotatable regulator 706. For example, in some embodiments, the blowing jet system 700 may include rotary bearings and a motor (e.g., a stepper motor, not shown) coupled with and configured to rotate the rotatable regulator 706 via a belt drive or other coupling mechanism. One or more motors driving the rotatable regulators 706 of the blowing jets 702 may be controlled via a control signal generated by the controller device 304, thereby controlling the force induced by the blowing jets 702 on the blade 102. In some embodiments, the bearings may have an eccentricity equal to variable gap of the blowing jets 702 (discussed below).

The blade 102 may have a length 708, measured from the center of the axis of the rotor 112 to the tip 206 of the blade 102. The longitudinal length of the rotatable regulator 706 may take any suitable value. For example, in some embodiments, a rotatable regulator 706 may have a longitudinal length approximately equal to 10% of the length 708 of the blade.

In some embodiments, one or more rotatable regulators 706 may be distributed only in certain portions of the blade 102. In some embodiments, one or more rotatable regulators 706 may only be located in the outer 10% of the length of the blade 102 (i.e., the 10% of the blade closest to the tip 206), and no rotatable regulators 706 may be located in the 90% of the blade closest to the root 208. For example, a single rotatable regulator 706 having a length equal to 10% of the length of the blade 102 may be positioned proximate to the tip 206 of the blade 102. In other embodiments, multiple rotatable regulators 706 having lengths that together cover a length equal to 10% of the length of the blade 102 may be positioned proximate to the tip 206 of the blade 102. For example, each rotatable regulator 706 may have a length of 1 foot, 2 feet, or 3 feet (spaced apart by a small amount, such as a few inches), and multiple rotatable regulators 706 may be aligned to provide an outer portion of the length of the blade 102. Providing forces for CCC only in this outer portion of the radius of a blade 102 may be adequate for successful infrasound and fatigue mitigation in some embodiments. The appropriate percentage and location of blowing jets for CCC may vary depending on the application; for example, including rotatable regulators in only the outer 5% of a blade radius may require stronger jets to achieve the desired thrust levels.

The blowing jet system 700 may provide a thin “wall-jet” of high velocity air that is discharged from, selectably, the suction side or the pressure side of the blade 102, and flows tangentially over a rotatable regulator 706 that may be disposed proximate to and form the trailing edge 202. The blowing jet systems and techniques disclosed herein may be capable of aerodynamic lift modulation of large magnitude with minimal mechanical and structural actuator considerations. When used for dynamic lift control, this approach to circulation control may be subject to the response characteristics of amplitude and phase dictated by classic unsteady aero/hydro-dynamic mechanisms.

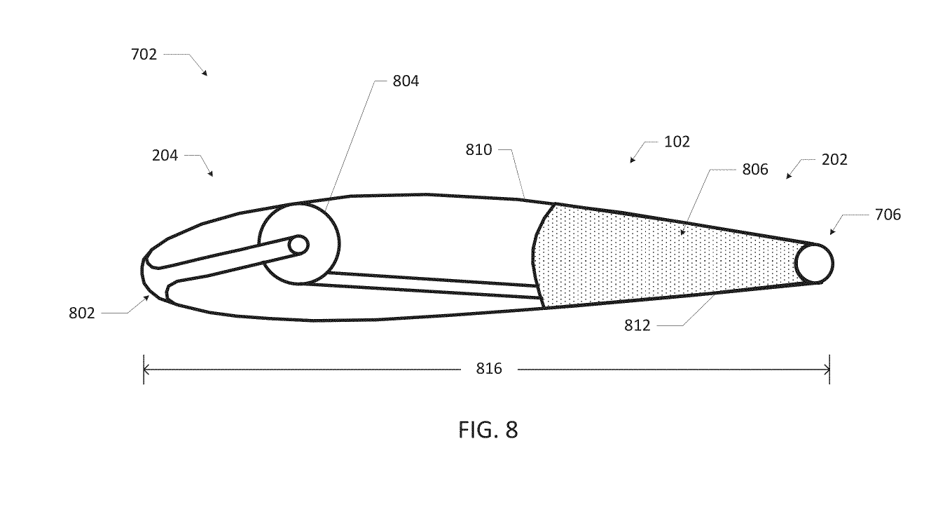

In some embodiments, the rotatable regulator 706 of the blowing jet 702 may include a cylinder having a longitudinal axis arranged approximately in parallel with a portion of the trailing edge 202 of the blade 102 (e.g., such that the edge of the cylinder forms a portion of the trailing edge 202). FIG. 8 is a blade cross-sectional view (taken at the cross-sectional indicator 704 of FIG. 7) of an embodiment of the blowing jet 702 of FIG. 7. In some embodiments, the blade 102 may have a chord having a length 816. The blowing jet 702 may include a rotatable regulator 706 and a reservoir of pressurized air 806. The rotatable regulator 706 may be rotatable about an axis going into the plane of the drawing. The rotatable regulator 706 may be disposed at the trailing edge 202 of the blade 102, and may be disposed between a first face 810 of the blade 102 and a second face 812 of the blade 102 (opposite to the first face 810). The reservoir 806 may be disposed between the first face 810 and the second face 812 or may be a structure separate from the blade 102.

In some embodiments, the reservoir 806 may be pressurized by a pump 804 (e.g., an electric blower or compressor). The pump 804 may take air provided by an inlet 802 (disposed on the leading edge 204 of the blade 102), and may pressurize the provided air for storage in the reservoir 806. In some embodiments, the system 300 includes a reservoir of pressurized air in the pillar 106 or nacelle 104 of the wind turbine 100 (not shown) and an air conduit system (such as a tubular spar, not shown) to provide air from the reservoir to the one or more blowing jets disposed proximate to the trailing edge of the blade, and an air conduit system to provide air from the reservoir to the rotatable regulator 706. Access to any pressurized air reservoir may be provided via one or more rotational and/or stationary seals. In some embodiments, each of one or more blades 102 may include their own contained, pressurized air reservoirs, located within an interior of the blade. In some embodiments, the pressure of the air in the reservoir 806 may be partially supplied by the centrifugal pumping effect of the inlet 802 and associated ducts rotating as the blades 102 rotate.

In some embodiments, the blowing jet system 700 may be built into the blades of a newly-built wind turbine rotor, or may be added as a modification to an existing rotor.

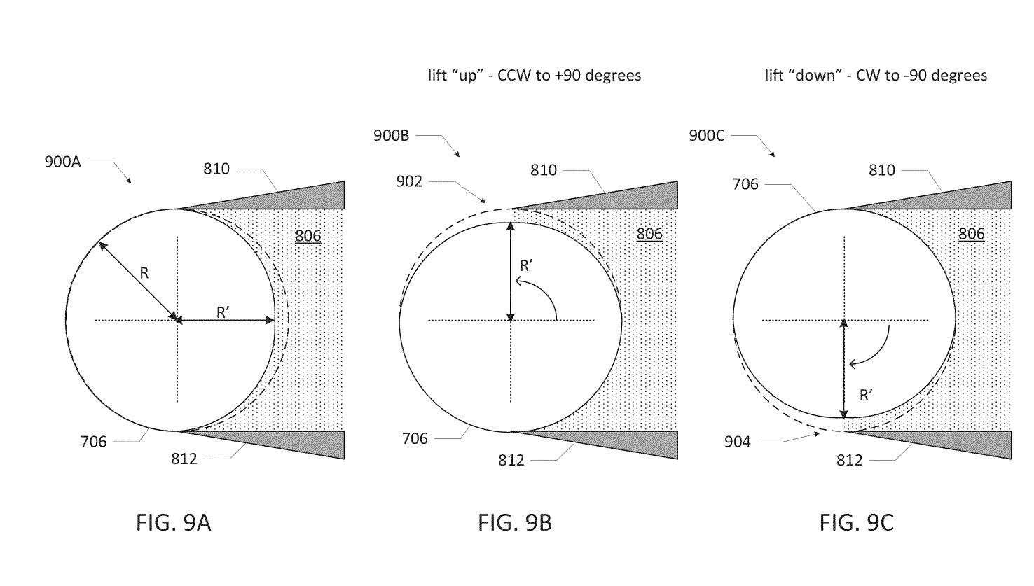

In some embodiments, the rotatable regulator 706 may be shaped as an eccentric cylinder. As used herein, an “eccentric cylinder” may have a cross-section that is approximately circular with a nominal radius, but has a reduced radial dimension for a portion of the circumference. FIGS. 9A-9C are cross-sectional views of various angular position configurations of a rotatable regulator 706 in an embodiment of the blowing jet 702 of FIG. 8. As shown in FIGS. 9A-9C, the rotatable regulator 706 may be shaped as an eccentric cylinder having a portion with a nominal radius (indicated by R) and a portion with a reduced radius (indicated by R′). In some embodiments, the nominal radius of the rotatable regulator 706 may be approximately 2.5% of the length 816 of a chord of the blade 102 (FIG. 8). In some embodiments, the reduced radius R′ may be approximately 2 millimeters shorter than the nominal radius R of the eccentric cylinder. For example, the reduced radius R′ may be 28 millimeters, while the nominal radius R may be 30 millimeters with a smooth (e.g., linear) transition between the reduced radius R′ and the nominal radius R. As discussed below, this may enable the formation of a nozzle with a mouth gap dimension that is adjustable by rotation of the rotatable regulator 706 about its nominally radially oriented long axis.

The rotatable regulator 706 may be controllable to rotate to orient the reduced radius portion toward the first face 810 of the blade 102, toward the reservoir 806, and/or toward the second face 812 of the blade 102, or in any other desired orientation. FIG. 9A depicts a configuration 900A in which the rotatable regulator 706 is rotated to orient the reduced radius portion toward the reservoir 806. As shown in FIG. 9A, the nominal radius portion of the rotatable regulator 706 is oriented so as to substantially span the distance between the first face 810 and the second face 812 to substantially prevent air from the reservoir 806 from escaping past the rotatable regulator 706.

FIG. 9B depicts a configuration 900B in which the rotatable regulator 706 is rotated to orient the reduced radius portion toward the first face 810. As shown in FIG. 9B, a gap 902 is present in the configuration 900B between the first face 810 and the rotatable regulator 706. Air from the reservoir 806 may escape through the gap 902, forming a blowing jet. The air escaping through the gap 902 as a blowing jet may induce a lift on the blade 102 in a direction opposite to the direction of escape and with a magnitude related to the pressure differential between the reservoir 806 and the ambient environment, as well as the size of the gap, among other things. In some embodiments, the magnitude and/or direction of the force induced on the blade 102 by the blowing jet may be adjusted by changing the orientation of the rotatable regulator 706 (thereby changing the size and geometry of the gap 902), among other ways. In some embodiments, the discharge velocity of the blowing jet may be approximately twice the speed of the tip 206 of the blade 102. This may require, for example, pressurization in the reservoir 806 of approximately 2 pounds per square inch above ambient pressure.

FIG. 9C depicts a configuration 900C in which the rotatable regulator 706 is rotated to orient the reduced radius portion toward the second face 812. As shown in FIG. 9C, a gap 904 is present in the configuration 900C between the second face 812 and the rotatable regulator 706. Air from the reservoir 806 may escape through the gap 904, forming a blowing jet. As discussed above with reference to the gap 902, the air escaping through the gap 904 as a blowing jet may induce a lift on the blade 102, which may have a magnitude and/or direction that may be adjusted by changing the orientation of the rotatable regulator 706 (among other ways).

By rotating the rotatable regulator 706 to control the location of the jet emitted from the trailing edge 202 of the blade 102, in response to a control signal from the controller device 304, the forces experienced by the blade 102 may be dynamically controlled to mitigate infrasound and/or blade fatigue. In particular, by modifying the gaps formed between the rotatable regulator 706 and the faces 810 and 812 of the blade 102 at the trailing edge 202, the lift on the blade 102 may be modified. If a gap is introduced on the suction side, the lift will be increased, and vice versa for a gap on the pressure side.

Under conditions that can be approximated as a known, constant air supply pressure, the controlled lift induced by a jet blowing through the gap between the rotatable regulator 706 and the faces 810 and 812 may be proportional to the dimension of the nozzle gap (a dimension referred to herein as G). Thus, the system 300 may provide lift control by rotation of the rotatable regulators 706 (i.e., by adjusting the position of one side of the jet aperture).

When the system 300 is configured to counter time-varying lift forces by means of feedback from sensed blade root stresses, for example, the fatigue-inducing bending moments on the blades 102 may be reduced. Further, when operating collectively in response to sensed blade motions, the fluctuating loads on the rotor 112, nacelle 104, and pillar 106 may be mitigated and the infrasound radiation controlled when operating in large-scale turbulent winds. In particular, wind turbine fatigue and noise remediation may be achieved by boundary layer control via tangential, streamwise blowing, when applied to either or both the pressure and suction sides of the blade near the trailing edge, to largely prevent the flow separation and vortex shedding responsible for the broadband “whooshing” noise reported during wind turbine operation. Two-dimensional, high velocity air “wall-jets” may supercharge the friction-retarded boundary layers under the pressure and suction-side flows of the blade 102, and may “stick” to a contour of the trailing edge 202 (e.g., a circular trailing edge, as shown in FIG. 8) without separation, due to the Coanda effect.

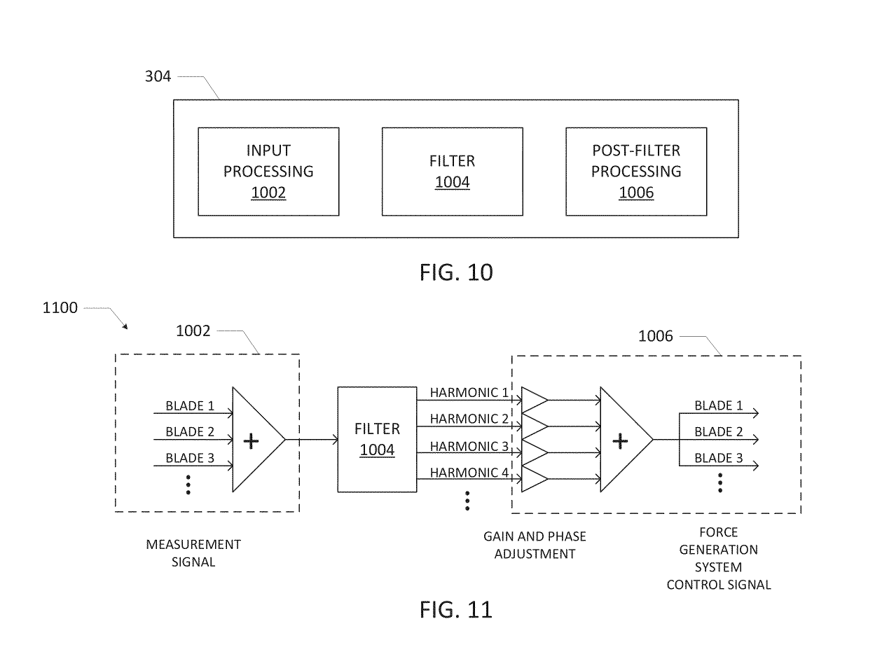

FIG. 10 is a block diagram of an embodiment of the controller device 304 of the system 300 (FIG. 3). As noted above, the controller device 304 may be configured to generate a control signal for provision to the force generation system 306 to reduce the response of the blade 102 to turbulence or flow non-uniformity. In some embodiments, the controller device 304 may generate the control signal based at least in part on the measurement signal generated by the measurement system 302. The controller device 304 may include input processing circuitry 1002, filter circuitry 1004, and post-filter processing circuitry 1006. The controller device 304 may be provided by any suitable analog, digital, or other computational components (such as one or more processing devices or specialized circuits).

The input processing circuitry 1002 may be configured to perform any of a number of processing operations, such as smoothing, low-, high-, or band-pass filtering, or combining of multiple sub-signals of a measurement signal. In some embodiments, the measurement signal provided by the measurement system 302 may include multiple sub-signals. Each sub-signal may represent an output signal from multiple measurement devices included in the measurement system 302. For example, the measurement signal may include sub-signals from each of a plurality of strain gauges disposed on a corresponding plurality of blades 102. In some embodiments, the measurement signal may include one sub-signal for each blade 102 in the rotor 112.

In embodiments in which the measurement signal includes multiple sub-signals, the input processing circuitry 1002 may combine these multiple sub-signals in any of a number of ways, such as summing or averaging. The input processing circuitry 1002 may generate processed data, based on the measurement signal, to be provided to the filter circuitry 1004. In some embodiments, the input processing circuitry 1002 may not be present and the measurement signal may be provided to the filter circuitry 1004.

The filter circuitry 1004 may be coupled with the input processing circuitry 1002 and may be configured to filter the processed data output from the input processing circuitry 1002 (or other signal input to the filter circuitry 1004). In some embodiments, the filter circuitry 1004 may filter the processed data to identify components of the processed data at frequencies corresponding to a plurality of multiples of a rotation rate of the blades 102 of the wind turbine 100. These multiples of the rotation rate may be referred to as “harmonics.” For example, in some embodiments, the filter circuitry 1004 may perform a Fourier or other frequency analysis technique to identify a magnitude and phase of components of the processed data for each of several harmonics of the rotation rate. In some embodiments, the filter circuitry 1004 may be implemented as a set of analog or digital bandpass filters, each tuned to a different frequency equal to one of harmonics of interest. The filter circuitry 1004 may generate filtered data, based on the measurement signal, to be provided to the post-filter processing circuitry 1006. In some embodiments, the filtered data may include a complex quantity for each harmonic, representative of the magnitude and phase of the harmonic in the data output by the input processing circuitry 1002.

The post-filter processing circuitry 1006 may be coupled with the filter circuitry 1004 and may be configured to perform any of a number of processing operations on the filtered data generated by the filter circuitry 1004. In some embodiments, the post-filter processing circuitry 1006 may use the magnitude and phase information for each of the rotation rate harmonics (generated by the filter circuitry 1004) and generate control signals for provision to the force generation system 306 to control forces to be applied to the blades 102 to achieve a desired performance result. For example, the post-filter processing circuitry 1006 may sum the complex quantities output from the filter circuitry 1004 to yield a measure of the radiation-generating average squared-force on the blades 102. In some embodiments, multiple blades 102 of the wind turbine 100 may include components of a force generation system, each configured to apply forces to their respective blades 102, and the control signals provided by the controller device 304 may be identical for each of the multiple blades 102. In some embodiments, the controller device 304 may generate different control signals for different ones of multiple blades 102. The post-filter processing circuitry 1006 may include power amplification (e.g., by commercially available analog amplification equipment) to generate control signals of the appropriate type and magnitude for input to the force generation system 306.

FIG. 11 is a schematic illustration of an embodiment 1100 of the controller device 304 of FIG. 10 for mitigation of radiated infrasound. In FIG. 11, the input processing circuitry 1002 may receive a measurement signal including multiple sub-signals, each from a respective different one of multiple blades 102, and may include a summing device configured to sum these different sub-signals into a composite signal. In some embodiments, the sub-signals may represent the axial vibration velocities of each of a plurality of blades 102. The filter circuitry 1004 may be configured to take the composite signal and filter it so as to identify a magnitude and phase for each harmonic of the blade rate. The blade rate may be provided to the filter circuitry 1004 by a blade rate measurement device (e.g., included in or separate from the measurement system 302), and thus may change as the operation of the wind turbine 100 changes. In some embodiments, the filter circuitry 1004 may identify the magnitude and phase of harmonics from the fundamental (corresponding to the blade rate) to 20 hertz (approximately equal to the lower bound of human hearing sensitivity) or greater.

The filter circuitry 1004 may output the magnitude and phase for each of several blade rate harmonics, and may provide this filtered data to the post-filter processing circuitry 1006. The post-filter processing circuitry 1006 may adjust the gain and/or phase of one or more of the blade rate harmonics. In some embodiments, the data representative of each harmonic may be subject to power amplification and phase correction adequate to command the force generation system 306 (including the force generation devices that are configured to act on each of multiple blades 102) to compensate for the lag introduced in unsteady aerodynamic response (by a harmonic change of airfoil geometry or its fluid-mechanical equivalent, plus that lead or lag determined computationally and/or experimentally in the mechanical motion response to applied lift forces when in rotary motion in an average wind.

As an illustrative example, an embodiment of the wind turbine 100 may have three blades 102 and a rotor 112 turning at 12 rotations per minute (RPM), corresponding to a rotation rate of 0.2 hertz when expressed as a frequency, and a blade rate of 0.6 hertz. The uniformly spaced blades 102 may be 120 degrees apart, thus requiring 120 degrees of turbine rotation to result in one full cycle of blade-rate activity.

If the direction of the wind incident on the rotor 112 is time-varying at a rate of 5×BR, or 3.0 hertz, the blades 102 will experience a particular force based on the aerodynamic lift response factor of the Theodorsen function, C(k). The Theodorsen function shown in FIG. 12 includes a point marked “X5,” representative of the ratio of the lift coefficient produced by a sinusoidally varying angle-of-attack (varying at 3.0 hertz) to that produced by an equal-but-constant angle-of-attack. The parameter k may be referred to as the “reduced frequency,” and is the product of the radian frequency and the airfoil semichord divided by the flight speed, as discussed above. The point marked “5×” represents, for example, a blade 102 having a 5 foot chord, traveling at 200 feet per second, and subject to a sinusoidally varying angle-of-attack at 3.0 Hz. Based on the Theodorsen function, at the 3.0 hertz varying angle-of-attack, a blade 102 should experience a lift response factor of about 0.75 with a phase lag of about 15 degrees. Since the angular period of 5×BR is 120/5=24 degrees, a phase lag of 15 degrees is equivalent to (15/360)×24=1.0 degrees of rotation. Thus, for incident wind having an angle-of-attack varying at 5×BR, the lift response to a sinusoidal command may lag by 1.0 degrees of rotor position and may yield only 75% of the commanded force (relative to incident wind whose associated mean angle-of-attack does not vary). In order to get the desired response, therefore, the control system 300 may, in this example, advance the timing of the rotor 112 by one degree of rotation and impose an amplification of 33% (1.0/0.75) to the commanded force (e.g., by performing gain and phase adjustment as discussed below with reference to FIG. 11).

Although the previous example discussed the effects of changes in the angle-of-attack of incident wind on the lift experienced by the rotor 112, the principles demonstrated therein also reflect the lift changes caused by the trailing-edge blowing jets of the force generation system 306 (via CCC).

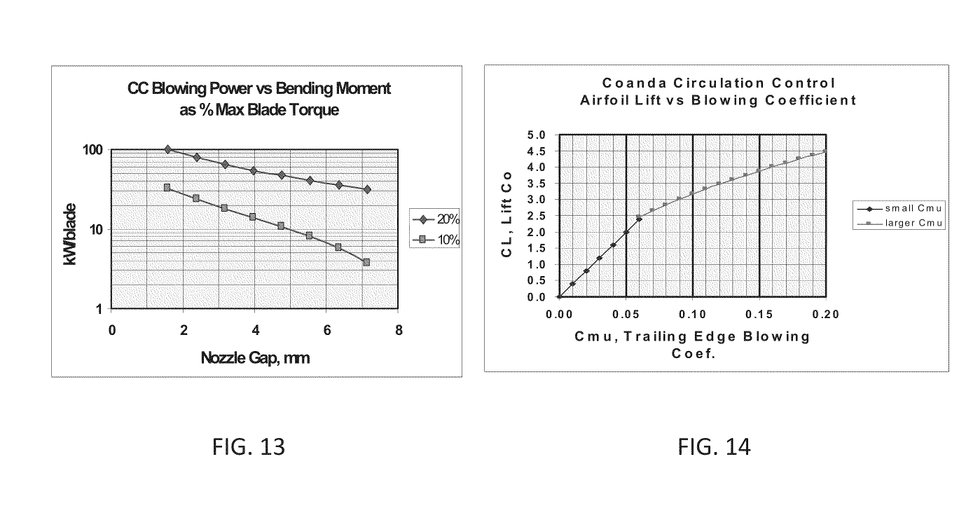

In some embodiments, the temporal and spatial aspects of three-dimensional unsteady aerodynamics may be modeled in accordance with a CFD model implemented by the controller device 304. Conventional CFD software packages may be used for this purpose, or specially configured hardware (e.g., a special purpose ASIC) may be used in order to achieve a desired fast response time. A CFD model may include the Theodorsen function of FIG. 12, the Coanda control blowing power versus bending moment relationship of FIG. 13, and the CL/Cmu relationship of FIG. 1, as discussed below.

In some embodiments, the two-dimensional C(k) discussed above may be applied “stripwise” to the three-dimensional flow field around the wind turbine blades 102 to accommodate the extra dimension. In particular, when the flow field changes with spanwise (e.g., radial position), a simple approximation that may be implemented is to divide the affected span region into a number of chordwise strips, treat each as though two-dimensional, and take their mathematically complex (i.e., having both real and imaginary parts) sum. This approximately may be suitable for considering the outer regions of the blade 102 (e.g., the outer 10%).

In practical implementations, the net force acting on the blade 102 and the surrounding air will differ from the CCC-driven lift force by the forces resulting from the vibratory motion velocities of the driven blade 102. If these velocities are those associated with a structural resonance, those forces may be in-phase with the vibratory velocities and may be experienced by the blade 102 as damping. In such a resonant case, the damping force (if all aerodynamic) may be directly subtracted from the applied driving force (while accounting for mode shape) to yield the net force capable of radiating the desired cancelling infrasound level. If the velocities are non-resonant, phase shifts will be present between the driving and response forces, and thus a vector subtraction (or addition) may be used. The vibratory forces and motions may be characterized by conventional computational dynamic models of the blades 102 (e.g., via transfer functions).

The post-filter processing circuitry 1006 may include a summing device configured to sum the adjusted gain/phase adjusted harmonics into a control signal. This control signal may be output to force generation components associated with each of a plurality of blades 102 to control the forces applied by the force generation system 306 to the plurality of blades 102. In some embodiments, forces generated by the force generation system 306 may be applied equally and simultaneously to all of the blades 102 of the rotor 112 in real time under the control of the controller device 304.

In some embodiments, the operations performed by the controller device 304 to generate a control signal (for the force generation system 306) based on the measurement signal (from the measurement system 302) may be configured to achieve any of a number of desired performance effects. In some embodiments, the controller device 304 is configured to generate a control signal to cause the force generation system 306 to generate force(s) to counter an expected fluctuating lift force averaged among a plurality of blades 102 due to operation in a turbulent environment (e.g., the large-scale turbulent environment of the wind boundary layer).

FIGS. 12-14 illustrate a number of relationships that may be used by the controller device 304 to determine what control signals to send to the force generation system 306 for effective infrasound mitigation. As discussed above, FIG. 12 is a graph of the Theodorsen function, C(k), the generic lift response to a sinusoidally varying aerodynamic circulation (e.g., as may be generated in response to angle-of-attack variations). C(k) is the factor for the unsteady lift response and may be multiplied by a steady state lift coefficient, CL, which is a function of the “blowing coefficient,” Cmu (as shown in FIG. 14 and discussed below). This graph demonstrates the mitigating effect of the velocities induced by the shed vorticity that is sinusoidally distributed in the wake behind the sinusoidal circulation. This graph may represent the lift response that may result from some embodiments of the control techniques disclosed herein (e.g., the controlled trailing edge jet embodiments) relative to quasi-steady state.

FIG. 13 is a graph of the estimated Coanda control blowing power versus blade-root bending moment, in accordance with various embodiments. In particular, FIG. 13 illustrates the estimated power required to produce a blade structural fatigue-preventing bending moment whose magnitude is expressed as a percentage (10% or 20%) of the shaft output torque per blade 102 of the wind turbine 100. FIG. 13 demonstrates the economy of utilizing increased values of the gap dimension G with reduced jet velocities while maintaining the values of Cmu necessary to produce the desired lift force-generating blade root bending moments.

FIG. 14 is a graph of the Coanda control lift versus blowing coefficient, in accordance with various embodiments. FIG. 14 illustrates a key relationship in CCC; that the lift coefficient CL is directly proportional to Cmu (for values of Cmu less than approximately 1/16). In particular, CL may be equal to approximately 40*Cmu for values of Cmu less than approximately 1/16. Both coefficient variables are dimensionless quantities.

In some embodiments, the controller device 304 and the force generation system 306 may be configured to use the information in FIGS. 12-14 to effectuate mitigation of infrasound as follows. The control operations may begin with an estimate of the unsteady thrust at a particular frequency of interest (e.g., an infrasound frequency). This estimate may be provided by, for example, a CFD analysis based on the measured wind velocity distribution and the characteristics of the turbine rotor, as discussed herein. As discussed above, this frequency may be a harmonic (i.e., multiple) of the blade passage frequency of the wind turbine 100. The estimated thrust may be divided by the number of blades 102 in the rotor 112 of the wind turbine 100 (e.g., three blades 102) to identify a thrust per blade. When focusing on the outer radii of the blades 102, the lift may be approximated by the thrust per blade.

Using the determined lift, the lift coefficient may be calculated using the relationship

CL=L/(rho*U0̂2*A/2)

where L is the determined lift, rho is the mass density of the air, U0 is the tangential velocity of the blade at a particular radial location (e.g., at 0.975*R, where R is the radius of the blade 102), and A is the blade area where the driving force will be applied (e.g., calculated by one half of the product of the blade radius and the blade chord length).

Given CL, Cmu may be determined using the relationship of FIG. 14. For example, when operating in the small Cmu range, Cmu=CL/40. The controller device may use this value of Cmu to determine a steady state value for G (Gss), the nozzle gap discussed above, using the relationship:

Cmu=(Ui/U0)̂2(Gss/b)

where Ui is the velocity of the jet blowing through the gap caused by the rotatable regulator 706 and b is the semichord length of the blade 102. In some embodiments, the ratio Ui/U0 may be approximately 2. In some embodiments, the semichord length b may be approximately 0.75 meters, or 2.5 feet.

The controller device 304 may also determine a value of C using the Theodorsen function of FIG. 12 based on the wavenumber-semichord product, calculated in accordance with:

k=ω*b/U

where ω is the blade passage frequency and U is the average relative velocity (e.g., the tip speed multiplied by 0.975).

The controller device 304 may then divide the steady state value of G, Gss, by the determined value of C, resulting in G. This value may be complex, representing a magnitude and phase of the desired G. This magnitude and phase may be the control signals sent by the controller device 304 to the force generation system 306 (or the control signals may be indicative of the magnitude and phase), and the force generation system 306 may perform gain and phase adjustment on the wind turbine 100 by manipulating the rotatable regulators 706 (e.g., as discussed with reference to FIG. 11).

To illustrate this embodiment, the following paragraph uses example values for an illustrative wind turbine control system 300. This example is not limiting, but simply illustrates the scale of various variables in some embodiments of the systems disclosed herein. In this example, it is assumed that noise at 3 hertz is generated by a three-bladed wind turbine turning at 12 rotations per minute (such that the noise represents the fifth harmonic of blade rate), and that this noise has a sound pressure level of 75 decibels at 1000 feet away from the wind turbine. The wind turbine itself has a radius of 50 meters, and a value of b equal to 2.5 feet. The top speed of a blade of this wind turbine is approximately 196 feet per second. The ratio (Ui/U0) is assumed to be approximately equal to 2, and the area A is approximately 82 square feet. A CFD model may be used to estimate that the thrust on the three blades necessary to generate such noise may be approximately 573 pounds per blade.

Given these values the quantity CL may be approximately equal to 0.156, resulting in a value of 3.89×10̂-3 for Cmu. The steady state gap Gss is therefore approximately 0.74 millimeters, and the value of k is approximately 0.240. Using the data of FIG. 12, this value of b results in a value of C having a magnitude of 0.7 and a phase of −15 degrees. Thus, the gap G required to generate the desired force at 3.0 hertz is approximately 1.06 millimeters with a phase advance of approximately 1 degree. Thus, if the rotatable regulator 706 is chosen so as to have a maximum gap of 2 millimeters at the middle of a 180 degree “tent-shaped” cylinder (e.g., as discussed below with reference to FIG. 17), the controller device 304 may command the force generation system 306 to oscillate at approximately 90*1.06/2=47.6 degrees sinusoidally at 3.0 hertz with a 1 degree phase advance. If the offending 3 hertz thrust has a phase angle of 6 degrees (for example), the phase for the desired gap G would be 5 degrees to counter the aerodynamic lag of 1 degree in force production.

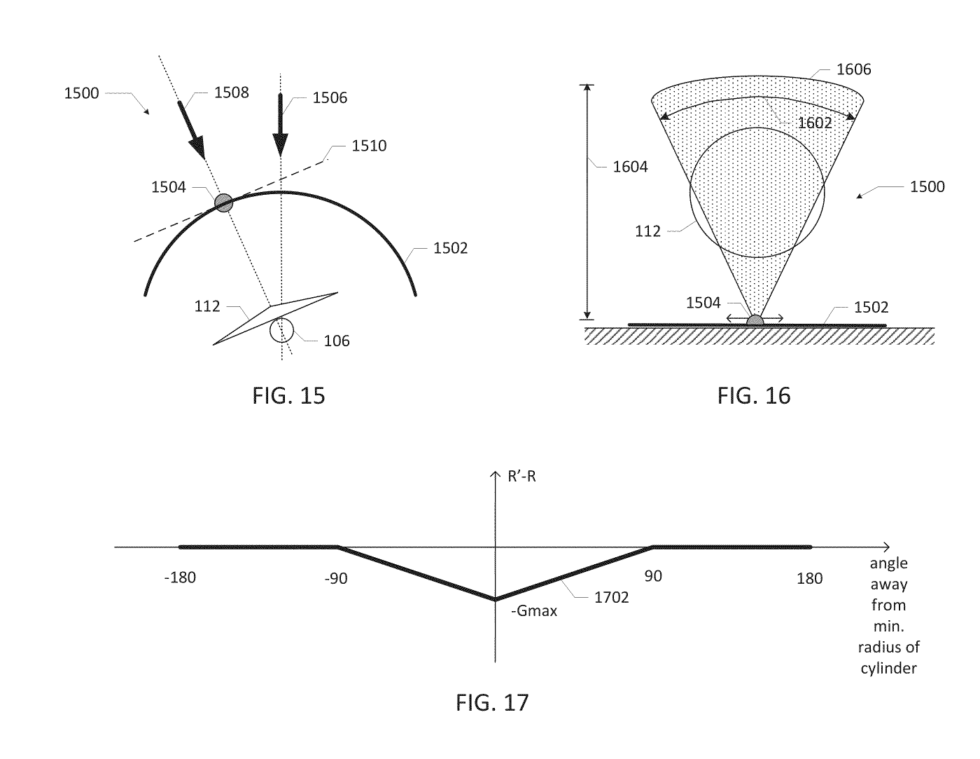

FIGS. 15 and 16 are views of a track-mounted sonic detection and ranging (SODAR) system 1500 for measuring the wind velocity distribution around the wind turbine 100, in accordance with various embodiments. In particular, FIG. 15 is a top view of a SODAR system 1500 arranged around a wind turbine 100, and FIG. 16 is a side view of the SODAR system 1500 from a position “facing” the disc of the rotor 112 of the wind turbine 100 and the SODAR instrument 1504. The SODAR system 1500 may be included in the wind turbine control system 300, as discussed below.

The SODAR system 1500 may include a track 1502 (e.g., on the ground) on which the SODAR instrument 1504 is positioned (e.g., on wheels or a belt) so as to be movable around the track 1502. In some embodiments, the track 1502 may be laid out as a circle or a circular arc, and a radius of the track 1502 may be greater than or equal to the diameter of the rotor 112 of the wind turbine 100. For example, the track 1502 may be a circular arc with a radius that is approximately equal to the diameter of the rotor 112. In some embodiments, the track 1502 may be a circular arc with a radius that is approximately equal to the diameter of the rotor 112. This would result in a column of air (for CFD calculations) that is as “long” as it is “wide.” The track 1502 may be disposed around the pillar 106 of the wind turbine 100. For example, the track 1502 may be laid out as a circle or circular arc that is approximately centered on the center of the pillar 106 (from a top view).

In the embodiment illustrated in FIG. 15, the track 1502 describes a circular arc. The track 1502 may be arranged so that a center point of the circular arc may be aligned with the most probable direction of strong wind incoming to the wind turbine 100, as viewed from the wind turbine 100. This is illustrated in FIG. 15 as the direction 1506. This most probable direction may be determined by examining collected wind speed and direction data in the vicinity of the wind turbine 100, for example. The length of the circular arc of the track 1502 may be selected to approximately match the probable range of directions of strong wind incoming to the wind turbine 100, as viewed from the wind turbine 100. For example, the length of the circular arc of the track 1502 may be selected so as to “cover” the angular directions from which a predetermined percentage (e.g., 75% or greater) of the power of the wind impinging on the rotor 112 arises. As noted above, the position of the SODAR instrument 1504 on the track 1502 (e.g., the angular position with respect to the wind turbine 100) may be adjustable. In particular, the SODAR instrument 1504 may be movable around the circular track 1502 so that it can be dynamically positioned to an angular position “upwind” of the wind turbine 100 at any given time. For example, the SODAR instrument 1504 may be movable so as to allow the SODAR instrument 1504 to be “lined up” with the current wind direction (e.g., the direction 1508), following the heading of the rotor 112 of the wind turbine 100.

The SODAR instrument 1504 may be “upward-facing” in the sense that it is oriented to detect the wind velocity distribution in a plane 1510 perpendicular to the plane of the circular track 1502, as shown in FIG. 16. In such a position, the SODAR instrument 1504 may measure the velocity distribution of the incoming wind in a plane 1510 perpendicular to the direction of travel of the wind. The SODAR instrument 1504 may generate a beam that sweeps through a fan-shaped, vertical, planar area 1606 having an angular width 1602 that approximately encompasses the axial geometric projection of the area of the rotor 112 and having a height 1604 that is approximately equal to that of the projection, as shown in FIG. 16. In some embodiments, the area 1606 swept by the SODAR beam may not exceed the circular projection of the rotor 112 since the cross-section of the wind column may expand as the air approaches the rotor 112 due to its load-related thrust (or drag), and thus the cross-section of the relevant wind column in the plane 1510 monitored by the SODAR instrument may be smaller than the diameter of the rotor 112. As the wind direction (e.g., the mean or maximum wind direction) changes, the SODAR instrument 1504 may be repositioned so as to be able to continuously measure the wind field in an area that largely includes the area from which wind impinging on the rotor 112 will travel.

The SODAR instrument 1504 may be any suitable, conventionally known SODAR instrument capable of performing the monitoring discussed above. The SODAR instrument 1504 may be mounted on wheels or a belt, and may be provided with a motor or other driver to move the SODAR instrument 1504 along the track 1502 to a desired location in response to a control signal from the controller device 304.

The measurement system 302 may include components (e.g., computer hardware and communication components) configured to apply a CFD model (as known in the art) to the SODAR data generated by the SODAR instrument 1504 to generate wind velocity distribution data. The measurement system 302 may be configured (e.g., programmed or provided with special-purpose hardware) to take into account the load-induced deceleration and associated broadening of the wind stream between the monitoring plane 1510 of the SODAR instrument 1504 and the rotor 112. The wind velocity non-uniformities and their axial distribution may be subject to known analysis procedures to predict the periodic thrust forces generated at the blade-rate frequency bands in a selected small time interval around the gathering of data. Examples of such analysis procedures are described in N. A. Brown, “Aspects of the Noise of Propellers Operating in Turbulent Flows,” NCA-Vol. 15/FED-Vol. 168, Flow Noise Modeling, Measurement and Control, ASME 1993.

In a feed-forward embodiment, the predictions of the measurement system 302 may be used by the controller device 304 to generate control signals for the force generation system 306. These control signals may instruct the force generation system 306 to adjust the thrust/lift on the blades 102 of the wind turbine 100, as described above, in order to cancel or otherwise counter infrasound radiated from the wind turbine 100. The SODAR-related hardware included in the measurement system 302 and the controller device 304 may be selected so that the measurement, computational, and active control processes may be carried out within the time it takes for air “particles” to travel between the monitoring plane 1510 of the SODAR instrument 1504 and the rotor 112.

As discussed above, in some embodiments, the force generation system 306 may include one or more rotatable regulators for governing the flow of jets. In particular, FIGS. 9A-9C illustrated a rotatable regulator 706 in various angular positions to achieve various nozzle gap positions. Depending upon the relative shapes of the faces 810 and 812 of the blade 102 and the rotatable regulator 706, different angular rotations of the rotatable regulator 706 may result in different nozzle gaps G.

FIG. 17 illustrates an example of nozzle gap variation achievable when a rotatable regulator having the linearized profile 1702 is used. In particular, FIG. 17 depicts the difference between the nominal radius R and the reduced radius R′ for an eccentric cylinder, as discussed above with reference to FIGS. 9A-9C. At a “0 degree” reference point, the eccentric cylinder has a radius R′, that radius increases to R in the +90 degree direction and in the −90 degree direction, and the radius is constant at R from +90 to +180 degrees and from −90 to −180 degrees. The largest gap achievable, Gmax, is equal to R−R′. The embodiment of FIG. 17 exhibits a bi-linear variation of the nozzle gap G as a function of the angle of rotation of the eccentric cylinder.

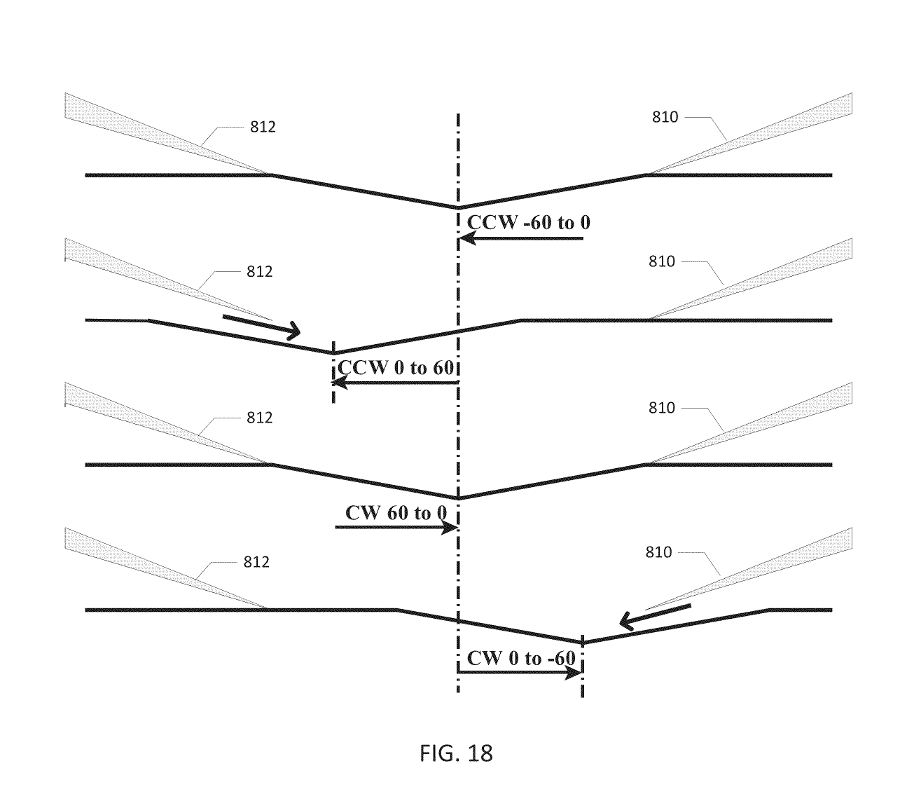

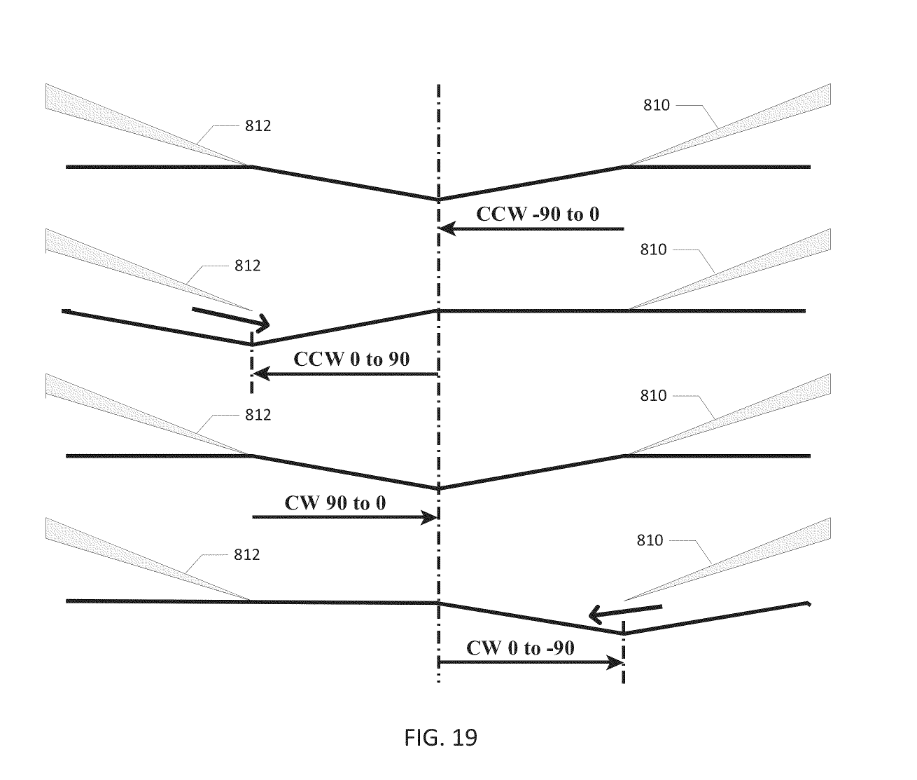

FIGS. 18 and 19 are schematic illustrations of nozzle gap variation for the eccentric cylinder of FIG. 17, in accordance with various embodiments. In particular, FIG. 18 illustrates the gaps (and therefore, jets) formed as the eccentric cylinder of FIG. 17 is rotated counterclockwise (CCW) to 60 degrees and then clockwise (CW) to −60 degrees, while FIG. 19 illustrates the gaps (and therefore, jets) formed as the eccentric cylinder of FIG. 17 is rotated counterclockwise to 90 degrees (to achieve the maximum gap) and then clockwise to −90 degrees (to achieve the maximum gap).

Although certain embodiments are illustrated and described herein, it will be appreciated by those of ordinary skill in the art that a wide variety of alternate and/or equivalent embodiments or implementations calculated to achieve the same purposes may be substituted for the embodiments shown and described without departing from the scope. Any suitable combination of the various features of the various embodiments disclosed herein is within the scope of this disclosure. Those with skill in the art will readily appreciate that embodiments may be implemented in a very wide variety of ways. This application is intended to cover any adaptations or variations of the embodiments discussed herein.

The following paragraphs describe various ones of the embodiments disclosed herein. Example 1 is a controllable, aerodynamic lift modulation system for application to the blades of a wind turbine to provide a specialized implementation of CCC capable of operating continually in a time-wise, spectral manner.

Example 2 may include the subject matter of Example 1, and may further specify that trailing edges of the wind turbine blades in a distal, radial interval of the blades having nominally circular-cylindrical form with a diameter that is nominally five percent of a chord length of an airfoil section of the blades.

Example 3 may include the subject matter of Example 2, and may further specify that the nominally circular-cylindrical trailing edge is manifest in separate but closely spaced radial segments that are capable of being controllably rotated about their long, nominally radial axes, independently or together, in time-wise oscillatory bi-directional angular motion in a frequency range from 0 to 20 hertz with controllable spectral waveform. In some embodiments, spectral angular motions of the nominally circular-cylindrical trailing edges are driven by close-coupled stepper motors or their functional equivalents.

Example 4 may include the subject matter of any of Examples 2-3, and may further specify that the nominally circular-cylindrical trailing edge segments have a cross-section with radially inward departures from circularity over a semicircular (180 degrees) angular extent, which, in one configuration, departs linearly with angle over a 90 degree interval and returns linearly to circularity through the following 90 degree angular interval.

Example 5 may include the subject matter of any of Examples 2-4, and may further specify that pressure and suction-side structural surfaces of the airfoil sections proximate to the nominally circular-cylindrical trailing edges are extended, stream wise, to a station coincident with a lengthwise position of the axes of rotatable edges, wherein those thickness-tapered surfaces terminate to form an upper or a lower gap when presented with a reduced radius arc of rotatable cylinders.

Example 6 may include the subject matter of Example 5, and may further specify that the gaps formed selectable, locally two-dimensional nozzles allowing discharger pressurized air from an interior of the airfoil in the form of a “wall-jet” tangent to a surface of the nominally circular-cylindrical trailing edges.

Example 7 may include the subject matter of Example 6, and may further specify that a selection of the wall-jet and its thickness is based on an instantaneous angular position of rotatable trailing edge cylinders.

Example 8 may include the subject matter of any of Examples 2-7, and may further specify that an oscillatory rotational position of the trailing edge cylinders are controlled, over a +/−90 degree range sinusoidally, according to a continuously updated frequency spectrum.

Example 9 may include the subject matter of any of Examples 2-8, and may further specify that the pressurized air resident in a reservoir proximate to a trailing edge mechanism of each rotor blade is supplied radially through the blade from either a hub-mounted or nacelle-based compressor, or from an individual, blade-enclosed, electrically powered compressor taking air from an inlet port located at a leading edge of the blade.

Example 10 is a system for mitigating infrasound by controllably creating thrust fluctuations on a rotor of a wind turbine, wherein the thrust fluctuations radiate as a dipole with magnitude and phase to nominally cancel or reduce the infrasound expected due to a timewise history of wind inflow turbulence.

Example 11 is a system for computing, from continued measurements of wind velocity non-uniformities through a plane upstream of a wind turbine, those disturbances that will pass to the plane of a rotor of the wind turbine, including deceleration due to rotor load; computing a spatial harmonic representation of those expected disturbances; and computing estimates of the expected rotor thrust fluctuations spectrum as a function of time.

Example 12 is a system for performing continuous measurement of the velocity or acceleration of the axial vibrations of the blades of a wind turbine and for computing estimates of the associated thrust fluctuations.

Example 13 is a system for performing continuous measurement of blade root bending stresses and four commanding individual blade lift magnitudes to generate compensating moments that limit such stresses.

Example 14 is a CCC system as described herein, included integrally with a wind turbine as the wind turbine is built or retrofitted to an existing wind turbine.

Example 15 is a wind turbine control system, including: a measurement system, including one or more measurement devices disposed on a blade of a wind turbine, to generate a measurement signal representative of a force on the blade or a vibratory velocity of a portion of the blade indicative of a response of the blade to turbulence or flow non-uniformity; a force generation system to generate lift proximate to a trailing edge of the blade by generating a blowing jet of air at the trailing edge of the blade in response to a control signal; and a controller device, coupled with the measurement device and the force generation system, to generate the control signal, based at least in part on the measurement signal, for provision to the force generation system to reduce the response of the blade to turbulence or flow non-uniformity.

Example 16 may include the subject matter of Example 15, and may further specify that the measurement system includes one or more velocimeters disposed proximate to a tip of the blade.

Example 17 may include the subject matter of Example 16, and may further specify that at least one velocimeter is to measure an axial vibratory velocity of the blade.

Example 18 may include the subject matter of any of Examples 15-17, and may further specify that the measurement system includes one or more strain gauges disposed proximate to a root of the blade.

Example 19 may include the subject matter of Example 18, and may further specify that at least one strain gauge is to measure an axial bending-related strain of the blade.

Example 20 may include the subject matter of any of Examples 15-19, and may further specify that the force generation system includes a blowing jet system for generating the blowing jet of air.

Example 21 may include the subject matter of any of Example 16-20, and may further specify that a blowing jet includes a reservoir of pressurized air coupled with a rotatable regulator.

Example 22 may include the subject matter of Example 21, and may further specify that the rotatable regulator includes an eccentric cylinder having a longitudinal axis arranged approximately in parallel with a portion of the trailing edge of the blade.

Example 23 may include the subject matter of Example 22, and may further specify that the eccentric cylinder has a portion having a nominal radius and a portion having a reduced radius.

Example 24 may include the subject matter of Example 23, and may further specify that the nominal radius is approximately 2.5% of a length of a chord of the blade.

Example 25 may include the subject matter of any of Examples 23-24, and may further specify that the rotatable regulator is to rotate to orient the reduced radius portion toward a first face of the blade, toward the reservoir, and toward a second face of the blade opposite to the first face of the blade.

Example 26 may include the subject matter of Example 25, and may further specify that a gap is formed between the first face of the blade and the reduced radius portion when the reduced radius portion is oriented toward the first face of the blade, and wherein a blowing jet is formed by pressurized air escaping from this gap.

Example 27 may include the subject matter of Example 26, and may further specify that a gap is formed between the second face of the blade and the reduced radius portion when the reduced radius portion is oriented toward the second face of the blade, and wherein a blowing jet is formed by pressurized air escaping from this gap.

Example 28 may include the subject matter of any of Examples 22-27, and may further specify that the rotatable regulator includes a plurality of eccentric cylinders having longitudinal axes arranged approximately in parallel with portions of the trailing edge of the blade, wherein the longitudinal axes are approximately aligned along the trailing edge of the blade.

Example 29 may include the subject matter of any of Examples 22-28, and may further specify that the force generation system comprises one or more rotatable regulators, each rotatable regulator comprises an eccentric cylinder, and a combined length of the one or more eccentric cylinders is approximately equal to 10% of a length of the blade.

Example 30 may include the subject matter of any of Examples 20-29, and may further specify that the force generation system includes a motor coupled with and configured to rotate the rotatable regulator via a belt or shaft drive.

Example 31 may include the subject matter of any of Examples 15-30, and may further specify that the force generation system includes an inlet disposed proximate to the leading edge of the blade to provide air to a reservoir.

Example 32 may include the subject matter of Example 31, and may further specify that the force generation system includes a pump to pressurize air provided by the inlet for storage in the reservoir.

Example 33 may include the subject matter of any of Examples 15-32, and may further specify that the force generation system includes a reservoir of independently supplied pressurized air in a pillar or nacelle of the wind turbine, one or more blowing jets disposed proximate to the trailing edge of the blade, and an air conduit system to provide air from the reservoir to the blowing jets.

Example 34 may include the subject matter of any of Examples 15-33, and may further specify that the controller is to filter data based on the measurement signal to identify components of the data at frequencies corresponding to a plurality of multiples of a rotation rate of the wind turbine.

Example 35 may include the subject matter of Example 34, and may further specify that the controller is to adjust a magnitude and phase of at least one identified component.

Example 36 may include the subject matter of Example 35, and may further specify that the control signal is based on the at least one identified component with the adjusted magnitude and phase.

Example 37 may include the subject matter of any of Example 35-36, and may further specify that the controller is to adjust a magnitude and phase of a plurality of identified components, and wherein the control signal is based on a sum of the plurality of identified components with the adjusted magnitudes and phases.

Example 38 may include the subject matter of any of Examples 15-37, and may further specify that the measurement system includes a plurality of measurement devices disposed on a corresponding plurality of different blades of the wind turbine, wherein the measurement signal includes measurement signals from each of the plurality of measurement devices.

Example 39 may include the subject matter of any of Example 16-38, and may further specify that the force generation system includes a plurality of force generation systems to generate forces proximate to a corresponding plurality of trailing edges of a corresponding plurality of blades.

Example 40 may include the subject matter of Example 39, and may further specify that the control signal includes a plurality of control signals for provision to each of the corresponding plurality of force generation systems.

Example 41 may include the subject matter of any of Examples 39-40, and may further specify that the control signal is to cause the plurality of force generation systems to generate forces to counter an expected fluctuating lift force averaged among the plurality of blades due to operation in a turbulent environment.

Example 42 is the measurement system of any of Examples 15-41.

Example 43 is the force generation system of any of Examples 15-41.

Example 44 is the controller of any of Examples 15-41.

Example 45 is a process for manufacturing any of Examples 15-41.

Example 46 is a method of operating the wind turbine control system of any of Examples 15-41.

What is claimed is:

1. A wind turbine control system, comprising:
a measurement system, including one or more measurement devices disposed on a blade of a wind turbine, to generate a measurement signal representative of a force on the blade or a speed of a portion of the blade indicative of a response of the blade to turbulence or flow non-uniformity;
a force generation system to generate lift proximate to a trailing edge of the blade by generating a blowing jet of air at the trailing edge of the blade in response to a control signal; and
a controller device, coupled with the measurement device and the force generation system, to generate the control signal, based at least in part on the measurement signal, for provision to the force generation system to reduce the response of the blade to turbulence or flow non-uniformity.

2. The wind turbine control system of claim 1, wherein the measurement system comprises one or more velocimeters disposed proximate to a tip of the blade.

3. The wind turbine control system of claim 2, wherein at least one velocimeter is to measure an axial vibratory velocity of the blade.

4. The wind turbine control system of claim 1, wherein the measurement system comprises one or more strain gauges disposed proximate to a root of the blade.

5. The wind turbine control system of claim 4, wherein at least one strain gauge is to measure an axial bending-related strain of the blade.

6. The wind turbine control system of claim 1, wherein the force generation system comprises a reservoir of pressurized air coupled with a rotatable regulator.

7. The wind turbine control system of claim 6, wherein the rotatable regulator comprises an eccentric cylinder having a longitudinal axis arranged approximately in parallel with a portion of the trailing edge of the blade.

8. The wind turbine control system of claim 7, wherein the eccentric cylinder has a portion having a nominal radius and a portion having a reduced radius.

9. The wind turbine control system of claim 8, wherein the nominal radius is approximately 2.5% of a length of a chord of the blade.

10. The wind turbine control system of claim 8, wherein the rotatable regulator is to rotate to orient the reduced radius portion toward a first face of the blade, toward the reservoir, and toward a second face of the blade opposite to the first face of the blade.

11. The wind turbine control system of claim 10, wherein a gap is formed between the first face of the blade and the reduced radius portion when the reduced radius portion is oriented toward the first face of the blade, and wherein a blowing jet is formed by pressurized air escaping from this gap.

12. The wind turbine control system of claim 11, wherein a gap is formed between the second face of the blade and the reduced radius portion when the reduced radius portion is oriented toward the second face of the blade, and wherein a blowing jet is formed by pressurized air escaping from this gap.

13. The wind turbine control system of claim 7, wherein the force generation system comprises one or more rotatable regulators, each rotatable regulator comprises an eccentric cylinder, and a combined length of the one or more eccentric cylinders is approximately equal to 10% of a length of the blade.

14. The wind turbine control system of claim 5, wherein the force generation system comprises a motor coupled with and configured to rotate the rotatable regulator via a belt drive.

15. The wind turbine control system of claim 1, wherein the force generation system comprises an inlet disposed proximate to a leading edge of the blade to provide air to a reservoir.

16. The wind turbine control system of claim 15, wherein the force generation system comprises a pump to pressurize air provided by the inlet for storage in the reservoir.

17. The wind turbine control system of claim 1, wherein the force generation system comprises a reservoir of pressurized air in a pillar or nacelle of the wind turbine, one or more blowing jets disposed proximate to the trailing edge of the blade, and an air conduit system to provide air from the reservoir to the blowing jets.

18. The wind turbine control system of claim 1, wherein the controller device is to filter data based on the measurement signal to identify components of the data at frequencies corresponding to a plurality of multiples of a rotation rate of the wind turbine.

19. The wind turbine control system of claim 18, wherein the controller device is to adjust a magnitude and phase of at least one identified component.

20. The wind turbine control system of claim 19, wherein the control signal is based on the at least one identified component with the adjusted magnitude and phase.
